(19) United States
(12) Patent Application Publication
(10) Pub. No.: US 2024/0329341 A1
(43) Pub. Date: Oct. 3, 2024

(54) LIGHT SOURCE MODULE AND XR GLASSES

(71) Applicant: TDK CORPORATION, Tokyo (JP)

(72) Inventor: Takashi AOYAGI, Tokyo (JP)

(73) Assignee: TDK CORPORATION, Tokyo (JP)

(21) Appl. No.: 18/382,685

(22) Filed: Oct. 23, 2023

(30) Foreign Application Priority Data
Mar. 29, 2023 (JP) 2023-052530

(51) Int. Cl. G02B 6/42; G02B 27/01

(52) U.S. Cl. CPC G02B 6/4267; G02B 6/426; G02B 27/0172; G02B 2027/0178

(57) ABSTRACT

A light source module includes a chip-on-carrier having a base and a laser diode, a planar lightwave circuit having a substrate and an optical waveguide, and a package having a housing portion configured to house the chip-on-carrier and the planar lightwave circuit. The housing portion has a substructure configured to form a bottom surface, one or more thermal vias penetrating through the substructure, and one or more bumps provided on the substructure. At least one of the bumps is arranged in contact with the planar lightwave circuit and arranged at a position at least partially overlapping the thermal vias when seen from above. The bumps come in contact with the thermal vias or the bumps and the thermal vias are bonded via a metallic pad.

### CROSS-REFERENCE TO RELATED APPLICATION

Priority is claimed on Japanese Patent Application No. 2023-052530, filed Mar. 29, 2023, the content of which is incorporated herein by reference.

### BACKGROUND OF THE INVENTION

### Field of the Invention

The present disclosure relates to a light source module and XR glasses.

### Description of Related Art

In recent years, attention has been paid to a light source module having a planar lightwave circuit (PLC) to which light is input from a laser diode (a semiconductor laser). Such a light source module can be used for XR glasses such as augmented reality (AR) glasses, virtual reality (VR) glasses, small projectors, and the like.

For example, Patent Document 1 discloses an integrated optical module including an integrated optical device having an optical waveguide; and a package configured to house the integrated optical device, wherein the integrated optical device has a base bottom surface and a substrate bottom surface that are both fixed on one inner surface of the package via a bonding layer containing a metal or resin. As described in Patent Document 1, a temperature of a laser diode (LD) is kept low by radiating heat generated by the LD (an optical semiconductor device) as a light source to the package.

Also, Patent Document 2 discloses a light-emitting diode package in which a base body for mounting a light-emitting diode element is formed using alumina ceramics, and thermal vias are formed in the base body.

Patent Document 3 discloses a light-emitting element housing package made of a ceramic and having a thermal via made of a copper-plated film in a portion of an insulating substrate on which the light-emitting element is mounted.

Patent Document 4 discloses a light-emitting diode in which a thermal via passing through a base body is formed in the base body for mounting a light-emitting diode element thereon and a radiator made of silicon carbide is pasted on the lower surface of the base body to make thermal contact with the thermal via.

However, conventional light source modules have insufficient heat radiation performance for heat generated by laser diodes and there has been a demand for improved heat radiation performance.

### Patent Documents

[Patent Document 1] PCT International Publication No. WO2021/149450

[Patent Document 2] Japanese Unexamined Patent Application, First Publication No. 2007-201156

[Patent Document 3] Japanese Unexamined Patent Application, First Publication No. 2009-260179

[Patent Document 4] Japanese Unexamined Patent Application, First Publication No. 2011-14769

### SUMMARY OF THE INVENTION

The present disclosure has been made in view of the above-described problems and an objective of the present disclosure is to provide a light source module having high heat radiation performance and XR glasses on which the light source module having the high heat radiation performance is mounted.

The present disclosure provides the following means to solve the above-described problems.

According to an aspect of the present disclosure, there is provided a light source module including: a chip-on-carrier having a base and a laser diode mounted on the base; a planar lightwave circuit having a substrate bonded to the base and an optical waveguide provided on the substrate and to which light emitted from the laser diode is input; and a package having a housing portion configured to house the chip-on-carrier and the planar lightwave circuit, wherein the housing portion has a substructure configured to form a bottom surface, one or more thermal vias penetrating through the substructure, and one or more bumps provided on the substructure, wherein at least one of the bumps is arranged in contact with the planar lightwave circuit and arranged at a position at least partially overlapping the thermal vias when seen from above, and wherein the bumps come in contact with the thermal vias or the bumps and the thermal vias are bonded via a metallic pad.

In the light source module according to the aspect of the present disclosure, heat generated by a laser diode and moved to a substrate of a planar lightwave circuit via a base of a chip-on-carrier can be efficiently radiated along a heat radiation path passing through a bump and a thermal via in that order. Therefore, the light source module according to the aspect of the present disclosure has high heat radiation performance.

Also, because XR glasses according to the aspect of the present disclosure are equipped with a light source module according to the aspect of the present disclosure, heat generated by a laser diode is efficiently radiated.

### BRIEF DESCRIPTION OF THE DRAWINGS

FIG. 1 is a plan view for describing an example of a light source module of the present disclosure and is a plan view showing a state in which a package cover is removed.

FIG. 2 is a cross-sectional view of the light source module shown in FIG. 1 along line A-A′ shown in FIG. 1.

FIG. 3 is a perspective view showing a chip-on-carrier and a planar lightwave circuit provided in the light source module shown in FIG. 1.

FIG. 4 is a perspective view showing an example of a method using the light source module shown in FIGS. 1 to 3.

FIG. 5 is a conceptual diagram for describing an example of XR glasses of the present disclosure.

FIG. 6 is a conceptual diagram showing a state in which an image is directly projected onto a retina through light output from the light source module in the XR glasses shown in FIG. 5. FIG. 7 is a cross-sectional view showing a heat distribution of a region of a subcarrier 20 and a substrate 40 near the subcarrier 20 when the light source module of an embodiment example is cut along line A-A′ shown in FIG. 1.

FIG. 8 is a cross-sectional view showing a heat distribution when a light source module of a comparative example is cut at a position corresponding to the light source module of the embodiment example.

### DETAILED DESCRIPTION OF THE INVENTION

In order to solve the above-described problems and implement a light source module with high heat radiation performance, the inventors of the present disclosure have thought that it is only necessary to provide a thermal via penetrating through a package configured to house a laser diode in the package. More specifically, the package is generally made of a material with low thermal conductivity. For this reason, the inventors of the present disclosure have thought that it is only necessary to radiate heat generated by the laser diode to the outside of the package through the thermal via.

However, sufficient heat radiation performance has also not been obtained in a light source module in which a chip-on-carrier and a planar lightwave circuit are housed in a package in which thermal vias are provided.

Therefore, the inventors of the present disclosure have paid attention to a heat radiation path of heat generated by a laser diode and thermal conductivity of each member forming a light source module and diligently studied these aspects for careful consideration using the chip-on-carrier and planar lightwave circuit shown below.

That is, the chip-on-carrier of the light source module having a base with a thermal conductivity of 120 W/mK to 170 W/mK and a laser diode mounted on the base was used. Also, the planar lightwave circuit including a substrate bonded to the base and having a thermal conductivity of 120 W/mK to 170 W/mK and an optical waveguide provided on the substrate and to which light emitted from the laser diode was input was used.

As a result, it has been found that it is only necessary to provide a heat radiation path by bonding the base of the chip-on-carrier and the substrate of the planar lightwave circuit, transferring the heat generated by the laser diode to the substrate via the base, and further efficiently radiating the heat moved to the substrate.

However, the substrate of the planar lightwave circuit is usually fixed to the bottom surface of the package using a conductive adhesive such as silver paste. A conductive adhesive layer formed by curing a conductive adhesive has significantly low thermal conductivity. Thus, even if the substrate of the planar lightwave circuit is fixed to the bottom surface of the package in which thermal vias are provided, the heat moved to the substrate of the planar lightwave circuit is not sufficiently transferred to the thermal vias and is not efficiently radiated to the outside.

Therefore, the inventors of the present disclosure have conducted further studies. The inventors of the present disclosure found that it is only necessary to provide a light source module in which one or more thermal vias having a thermal conductivity of 135 W/mK to 210 W/mK and penetrating through a substructure forming a bottom surface of a package and having a thermal conductivity of 3 W/mK to 40 W/mK are provided on the substructure, a planar lightwave circuit is provided in contact with bumps having a thermal conductivity of 80 W/mK to 210 W/mK provided on the substructure, at least one of the bumps is arranged at positions at least partially overlapping the thermal vias when seen from above, and the bumps and the thermal vias are in contact with each other or are bonded via a metallic pad having a thermal conductivity of 55 W/mK to 65 W/mK.

The inventors of the present disclosure have further studied and found that such a light source module has excellent heat radiation performance because the heat generated by the laser diode is radiated along a heat radiation path passing through the chip-on-carrier base, the substrate of the planar lightwave circuit, the bumps, and the thermal vias in that order and the heat generated by the laser diode and moved to the substrate of the planar lightwave circuit via the base of the chip-on-carrier can be efficiently radiated even if the planar lightwave circuit is fixed to the bottom surface of the package using a conductive adhesive such as silver paste, and thus conceived of the present disclosure.

The present disclosure includes the following aspects.

[1] A light source module including:
a chip-on-carrier having a base and a laser diode mounted on the base;
a planar lightwave circuit having a substrate bonded to the base and an optical waveguide provided on the substrate and to which light emitted from the laser diode is input; and
a package having a housing portion configured to house the chip-on-carrier and the planar lightwave circuit,
wherein the housing portion has a substructure configured to form a bottom surface, one or more thermal vias penetrating through the substructure, and one or more bumps provided on the substructure,
wherein at least one of the bumps is arranged in contact with the planar lightwave circuit and arranged at a position at least partially overlapping the thermal vias when seen from above, and
wherein the bumps come in contact with the thermal vias or the bumps and the thermal vias are bonded via a metallic pad.

[2] The light source module according to [1],
wherein the base has a thermal conductivity of 120 W/mK to 170 W/mK,
wherein the substrate has a thermal conductivity of 120 W/mK to 170 W/mK,
wherein the substructure has a thermal conductivity of 3 W/mK to 40 W/mK,
wherein the thermal via has a thermal conductivity of 135 W/mK to 210 W/mK,
wherein the bump has a thermal conductivity of 80 W/mK to 210 W/mK, and
wherein the metallic pad has a thermal conductivity of 55 W/mK to 65 W/mK.

In the present embodiment, thermal conductivity of each material is thermal conductivity in a temperature range of 0° C. to 200° C.

[3] The light source module according to [1] or [2],
wherein the base and the substrate are made of a material containing silicon,
wherein the substructure is made of aluminum oxide, and
wherein the bumps and the thermal vias are made of tungsten or molybdenun.

[4] The light source module according to [1] or [2], wherein the base and the substrate are bonded via a metallic bonding layer having a thermal conductivity of 55 W/mK to 65 W/mK.

[5] The light source module according to [1] or [2],
wherein the metallic pad is arranged in at least a region where the planar lightwave circuit is arranged on the substructure when seen from above, and
wherein the bump is arranged on the metallic pad in contact therewith.

[6] The light source module according to [5],
wherein the metallic pad is provided to extend to a region where the chip-on-carrier is arranged on the substructure when seen from above, and
wherein the chip-on-carrier is installed on the metallic pad via a conductivity adhesive layer having a thermal conductivity of 1 W/mK to 50 W/mK.

[7] XR glasses on which the light source module according to [1] or [6] is mounted.

Hereinafter, a light source module and XR glasses of the present embodiments will be described in detail with reference to the drawings as appropriate. In the drawings used in the following description, featured parts may be enlarged for convenience such that the features of the present disclosure are easier to understand, and dimensional ratios and the like of the respective components may be different from actual ones. Materials, dimensions, and the like exemplified in the following description are examples, the present disclosure is not limited thereto, and modifications can be appropriately made without departing from the spirit and scope of the present disclosure.

### Light Source Module

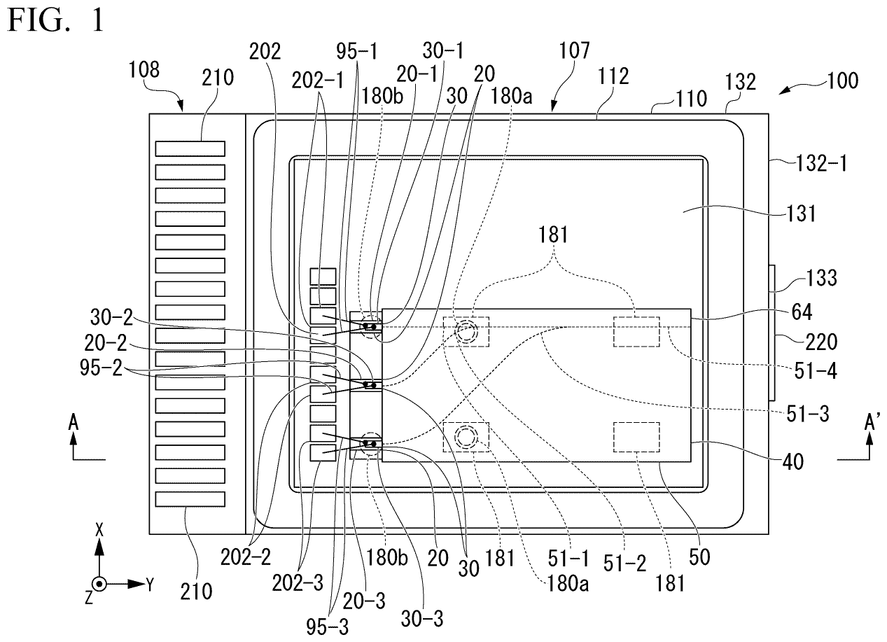

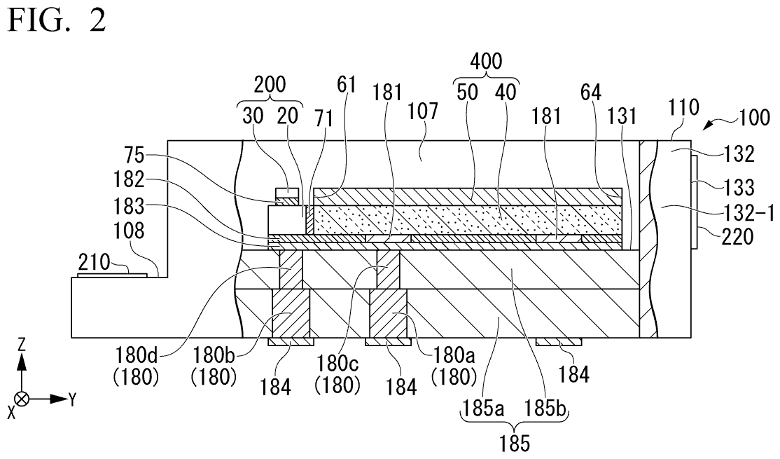

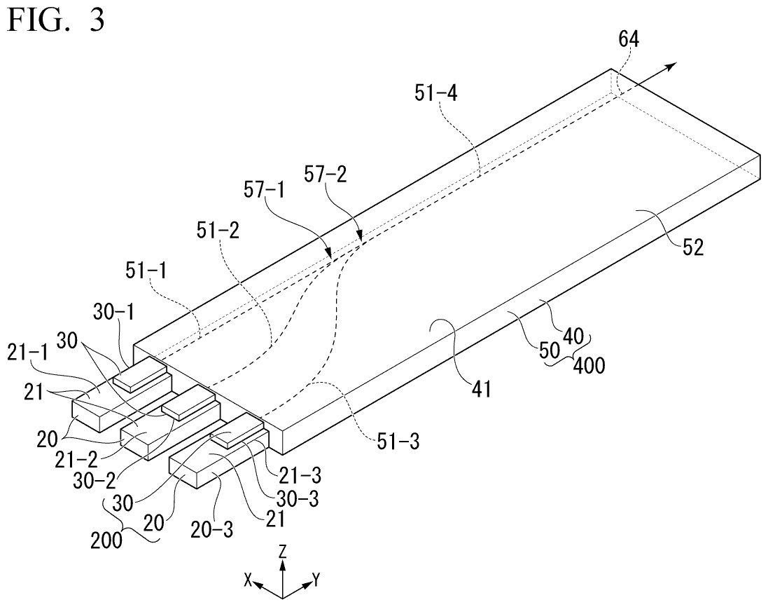

FIG. 1 is a plan view for describing an example of a light source module of the present disclosure and is a plan view showing a state in which a package cover is removed. FIG. 2 is a cross-sectional view of the light source module shown in FIG. 1 along line A-A′ shown in FIG. 1. FIG. 3 is a perspective view showing a chip-on-carrier and a planar lightwave circuit provided in the light source module shown in FIG. 1.

As shown in FIGS. 1 and 2, a light source module 100 of the present embodiment has a chip-on-carrier 200, a planar lightwave circuit 400, and a package 110 configured to house the chip-on-carrier 200 and the planar lightwave circuit 400. The light source module 100 in the present embodiment is a multiplexer that combines light of red (R), green (G), and blue (B) as the three primary colors of light.

### Chip-on-Carrier

As shown in FIGS. 1 to 3, the chip-on-carrier 200 has a subcarrier (base) 20 and a laser diode (LD) 30 mounted on the subcarrier 20.

In the following description, an output direction of light emitted from the laser diode (LD) 30 is assumed to be a y-direction. Also, a direction perpendicular to the y-direction and from the subcarrier 20 to the LD 30 is defined as a z-direction. Also, a direction orthogonal to the y-direction and the z-direction is defined as an x-direction.

In FIGS. 1 and 3, reference signs 20-1, 20-2, and 20-3 denote subcarriers 20. Each of these three subcarriers 20-1. 20-2, and 20-3 has a substantially rectangular parallelepiped shape and prescribed wiring and the like are provided in a known method.

Any one of the three subcarriers 20-1, 20-2, and 20-3 preferably has a thermal conductivity of 140 W/mK to 170 W/mK.

Examples of the three subcarriers 20-1, 20-2, and 20-3 include silicon (Si).

The three subcarriers 20-1, 20-2, and 20-3 may be made of different materials, or partially or entirely made of the same material.

As shown in FIGS. 1 and 3, reference signs 30-1, 30-2, and 30-3 denote laser diodes (LD) 30. The LD 30-1 is a laser diode that emits red light. For example, light with a peak wavelength of 610 nm or more and 750 nm or less can be used as the red light emitted by the LD 30-1. The LD 30-2 is a laser diode that emits green light. For example, light with a peak wavelength of 500 nm or more and 560 nm or less can be used as the green light emitted by the LD 30-2. The LD 30-3 is a laser diode that emits blue light. For example, light with a peak wavelength of 435 nm or more and 480 nm or less can be used as the blue light emitted by the LD 30-3. As these three laser diodes 30-1, 30-2, and 30-3, various types of commercially available laser elements can be used.

These three laser diodes (LD) 30-1, 30-2, and 30-3 are spaced apart from each other in a direction (x-direction) substantially perpendicular to the output direction (y-direction) of light emitted from each laser diode and provided on the upper surface 21 of the individual subcarriers 20. That is, as shown in FIG. 3, the LD 30-1 is provided on an upper surface 21-1 of the subcarrier 20-1. The LD 30-2 is provided on an upper surface 21-2 of the subcarrier 20-2. The LD 30-3 is provided on an upper surface 21-3 of the subcarrier 20-3.

Although an example in which one laser diode that emits red (R) light, one laser diode that emits green (G) light, and one laser diode that emits blue (B) light are provided will be described in the present embodiment, laser diodes that emit light other than red (R), green (G), and blue (B) light can also be used. Also, an arrangement of the three laser diodes emitting colors of red (R), green (G), and blue (B) is not limited to the arrangement shown in FIGS. 1 to 3 and can be changed as appropriate. Also, the number of laser diodes that emit red (R), green (G), and blue (B) light (and the number of subcarriers on which the laser diodes are mounted) is not particularly limited, and may be different or partially or totally identical according to each color of red (R), green (G), and blue (B) or can be appropriately determined in accordance with the purpose of the light source module 100 or the like.

The subcarriers 20-1, 20-2, and 20-3 and the laser diodes (LD) 30-1, 30-2, and 30-3 are preferably bonded via a metallic layer 75 provided between the subcarriers 20 and the laser diodes 30 as shown in FIG. 2.

The metallic layer 75 may be made of, for example, one or more types of metals selected from the group consisting of gold (Au), platinum (Pt), silver (Ag), lead (Pb), indium (In), nickel (Ni), titanium (Ti), tantalum (Ta), tungsten (W), an alloy of gold (Au) and tin (Sn), a tin (Sn)-silver (Ag)-copper (Cu)-based solder alloy (SAC), SnCu, InBi, SnPdAg, SnBiln, and PbBiln.

The metallic layer 75 may be made of a single metallic layer or may be made of a plurality of metallic layers.

Also, the metallic layer 75 between the subcarrier 20-1 and the LD 30-1, the metallic layer 75 between the subcarrier 20-2 and the LD 30-2, and the metallic layer 75 between the subcarrier 20-3 and the LD 30-3 may be formed of different materials, or may be partially or entirely formed of the same material.

A known method can be used as a method of forming the metallic layer 75. For example, a sputtering method, a vapor deposition method, a method of applying a metallic paste, and the like can be used.

### Planar Lightwave Circuit

As shown in FIGS. 1 to 3, the planar lightwave circuit (PLC) 400 has a substrate 40 and an optical waveguide 50 provided on the substrate 40 and to which light emitted from a laser diode 30 is input.

The substrate 40 has a substantially rectangular parallelepiped shape. The substrate 40 preferably has a thermal conductivity of 120 W/mK to 170 W/mK.

For example, the substrate 40 made of silicon (Si) and/or SiO₂ may be used.

As shown in FIGS. 1 and 3, the optical waveguide 50 has a core 51-1, a core 51-2, and a core 51-3 equal in number to the LD 30-1, the LD 30-2, and the LD 30-3, and cladding 52 surrounding the core 51-1, the core 51-2, and the core 51-3.

A thickness of the cladding 52 and widthwise dimensions of the core 51-1, the core 51-2, and the core 51-3 are not particularly limited.

The core 51-1, the core 51-2, the core 51-3, and the cladding 52 are made of, for example, quartz. The core 51-1, the core 51-2, and the core 51-3 are doped with impurities of germanium (Ge) or the like in an amount corresponding to a prescribed value.

The refractive indices of the core 51-1, the core 51-2, and the core 51-3 are greater than the refractive index of the cladding 52 by a prescribed value. Thereby, light input to each of the core 51-1, the core 51-2, and the core 51-3 propagates in each core while being totally reflected at an interface between each core and the cladding 52.

As shown in FIG. 3, the core 51-1, the core 51-2, and the core 51-3 have input surfaces 61 (see FIG. 2) to which light emitted from the LD 30-1, the LD 30-2, and the LD 30-3 is input. The core 51-1, the core 51-2, and the core 51-3 extend in the y-direction from the input surface 61 toward an output surface 64 and are gathered on the front side reaching the output surface 64 together, as shown in FIGS. 1 and 3. That is, the core 51-1, the core 51-2, and the core 51-3 approach each other toward the front in the y-direction and merge into one core 51-4.

In the present embodiment, the input surfaces 61 of the core 51-1, the core 51-2, and the core 51-3 are arranged to face output surfaces of the LD 30-1, the LD 30-2, and the LD 30-3, respectively. Thereby, at least a part of the red light emitted from the LD 30-1 can be input to the core 51-1, at least a part of the green light emitted from the LD 30-2 can be input to the core 51-2, and at least a part of the blue light emitted from the LD 30-3 can be input to the core 51-3. The red light, the green light, and the blue light emitted from the LD 30-1, the LD 30-2, and the LD 30-3 and input to the core 51-1, the core 51-2, and the core 51-3 propagate into the cores.

The red light propagating in the core 51-1 and the green light propagating in the core 51-2 are combined at a prescribed merging position 57-1 (see FIG. 3). Also, the red light and green light propagating in the core into which the core 51-1 and the core 51-2 merge and the blue light propagating in the core 51-3 are combined at the merging position 57-2 (see FIG. 3). The red light, the green light, and the blue light condensed at the merging position 57-2 propagate in the core 51-4 and reach the output surface 64. The three colors of light output from the output surface 64 are used according to the purpose of use of the light source module 100.

The optical waveguide 50 is manufactured on the upper surface 41 of the substrate 40 so that the substrate 40 and the optical waveguide 50 are integrated in a known semiconductor process including photolithography and/or dry etching that is used when a fine structure of an integrated circuit or the like is formed.

In the light source module 100 of the present embodiment, the subcarrier 20 of the chip-on-carrier 200 and the substrate 40 of the planar lightwave circuit (PLC) 400 are bonded in a known method. As shown in FIG. 2, the subcarrier 20 and the substrate 40 are preferably bonded via a metallic bonding layer 71.

The metallic bonding layer 71 may preferably have a thermal conductivity of 55 W/mk to 65 W/mK. The metallic bonding layer 71 having a thermal conductivity of 55 W/mK to 65 W/mK may be made of, for example, one or more types of metals selected from the group consisting of gold (Au), platinum (Pt), silver (Ag), lead (Pb), indium (In), nickel (Ni), titanium (Ti), tantalum (Ta), tungsten (W), an alloy of gold (Au) and tin (Sn), a tin (Sn)-silver (Ag)-copper (Cu)-based solder alloy (SAC), SnCu, InBi, SnPdAg, SnBiln, and PbBiln. The metallic bonding layer 71 may be made of a single metallic layer or may be made of a plurality of metallic layers.

On the other hand, as shown in FIG. 2, the laser diode 30 of the chip-on-carrier 200 and the optical waveguide 50 of the planar lightwave circuit (PLC) 400 are spaced apart by a prescribed distance. Therefore, a gap is formed in the y-direction between the input surface 61 of the optical waveguide 50 and the output surface of the laser diode 30 facing it.

### Package

As shown in FIGS. 1 and 2, the package 110 has a substantially rectangular parallelepiped cavity structure with an open upper surface and includes a housing portion 107 configured to house the chip-on-carrier 200 and the planar lightwave circuit 400, and an electrode portion 108 adjacent to the housing portion 107.

As shown in FIG. 2, the housing portion 107 includes a substructure 185 forming the bottom surface 131 of the package 110, a metallic pad 183 arranged on the substructure 185 in at least a region where the planar lightwave circuit 400 is arranged when seen from above, one or more bumps 181 arranged on the metallic pads 183 in contact therewith, one or more thermal vias 180 penetrating through the substructure 185, a thermal pad 184 provided around the thermal vias 180 on the lower surface of the substructure 185, and a sidewall portion 132 erected to surround the edge of the substructure 185 and having a substantially rectangular shape when seen from above.

As shown in FIG. 1, a metallic film 112 made of Kovar or the like is formed on the upper surface of the sidewall portion 132. The housing portion 107 is hermetically sealed with a cover (not shown) covering the upper surface and an internal space of the housing portion 107 is filled with an inert gas such as nitrogen (N₂).

In the present embodiment, as shown in FIG. 2, a laminated structure in which two layers of base materials, i.e., a first base material 185a and a second base material 185b installed on the first base material 185a, are laminated is installed as the substructure 185. Wiring (not shown) made of tungsten or the like and having a prescribed pattern shape is provided on the surface of the first base material 185a on the second base material 185b side.

The substructure 185 is not limited to a laminated structure in which two layers of base materials are laminated, and may be made of only one layer of a base material. Also, when the substructure 185 has a laminated structure in which a plurality of base materials are laminated, the substructure 185 may have three or more layers.

The substructure 185 (the first base material 185a and the second base material 185b in the present embodiment) has an insulating property, preferably has a thermal conductivity of 3 W/mK to 40 W/mK, more preferably has a thermal conductivity of 8 W/mK to 34 W/mK, and further preferably has a thermal conductivity of 18 W/mK to 29 W/mK.

The first base material 185a and the second base material 185b may be made of, for example, aluminum nitride (AlN), aluminum oxide (Al₂O₃), and the like. The first base material 185a and the second base material 185b may be made of the same material or may be made of different materials.

In the present embodiment, as shown in FIG. 2, the metallic pad 183 is provided on the substructure 185 in the entire region where the planar lightwave circuit 400 and the chip-on-carrier 200 are arranged when seen from above. Thus, the light source module 100 of the present embodiment can efficiently radiate heat from the planar lightwave circuit 400 to the thermal vias 180 and has better heat radiation performance. Also, in the present embodiment, the thermal via 180 is also arranged at a position where at least a part of the thermal via 180 overlaps the chip-on-carrier 200 when seen from above. Thus, the heat generated by the laser diode 30 of the chip-on-carrier 200 is radiated from a heat radiation path through which the chip-on-carrier 200, a conductive adhesive layer 182 to be described below, the metallic pad 183, and the thermal via 180 arranged at a position at least partially overlapping the chip-on-carrier 200 pass when seen from above. As a result, the light source module 100 has better heat radiation performance.

The metallic pad 183 is provided if necessary and may not be provided if not necessary. When the metallic pad 183 is provided, it may be provided in at least a region where the planar lightwave circuit 400 is arranged and may not be provided in a region where the chip-on-carrier 200 is arranged. In the present embodiment, as shown in FIG. 2, the metallic pad 183 is preferably provided on the substructure 185 when seen from above so that it extends to a region where the chip-on-carrier 200 is arranged as well as the planar lightwave circuit 400. This is because the light source module 100 has better heat radiation performance.

The metallic pad 183 preferably has a thermal conductivity of 55 W/mK to 65 W/mK.

The metallic pad 183 includes, for example, tungsten (W) or molybdenum (Mo).

In the present embodiment, as shown in FIGS. 1 and 2, a plurality of bumps 181 (four bumps 181 in the example shown in FIGS. 1 and 2) are arranged on the metallic pad 183 in contact therewith in a region where the planar lightwave circuit 400 is installed on the metallic pad 183. Thereby, the planar lightwave circuit 400 is arranged on the bumps 181 in contact therewith (see FIG. 2). In the present embodiment, at least one of the bumps 181 (two bumps 181 in the example shown in FIGS. 1 and 2) is arranged at a position at least partially overlapping the thermal via 180 when seen from above (see FIG. 1).

The bump 181 functions as a spacer that provides a prescribed gap between the substructure 185 and the planar lightwave circuit 400 (between the metallic pad 183 and the planar lightwave circuit 400 when the metallic pad 183 is provided). The number of bumps 181 is not particularly limited and can be appropriately determined in accordance with a size of the planar lightwave circuit 400, a size of the bump 181, and the like.

The thickness of the bump 181 is preferably 5 μm to 30 μm as an example. When the thickness of the bump 181 is 5 μm or more, the spacer function and the heat radiation improvement function become better.

The thickness of the bump 181 is preferably 30 μm or less because this does not interfere with miniaturization of the light source module 100.

The bump 181 preferably has a thermal conductivity of 80 W/mK to 210 W/mK, more preferably has a thermal conductivity of 135 W/mK to 210 W/mK, and further preferably has a thermal conductivity of 150 W/mK to 210 W/mK.

The bump 181 may be made of, for example, one or more types of metals selected from the group consisting of tungsten (W), molybdenum (M), nickel (Ni), gold (Au), and an alloy (CuW) of tungsten and copper. The bump 181 may be made of a single metallic layer or may be made of a plurality of metallic layers.

When the bump 181 is made of a single metallic layer, it is preferably made of tungsten (W: thermal conductivity of 150 W/mK to 180 W/mK) or molybdenum (Mo: thermal conductivity of 135 W/mK to 150 W/mK). Tungsten and molybdenum do not melt or vaporize at typical sintering temperatures when the substructure 185 is sintered. Thus, when the bump 181 is a single layer serving as a layer made of tungsten or a layer made of molybdenum, the bump 181 can be preferably formed using a method of printing a material serving as the bump 181 in a known method at a prescribed position on the substructure 185 on which the metallic pad 183 is formed and then baking the substructure 185.

When bump 181 is made of a plurality of metallic layers, a nickel layer and a gold layer are preferably laminated in that order on a layer made of tungsten or a layer made of molybdenum. In this case, this is because a nickel layer and a gold layer are laminated in that order in a plating method at a prescribed position on the substructure 185 on which a layer made of tungsten or a layer made of molybdenum is formed, thereby forming the bumps 181 simultaneously when an internal electrode pad 202 is provided. The nickel layer and the gold layer formed simultaneously with the internal electrode pads 202 have sufficiently high thermal conductivity and are thin layers. For example, the thickness of the layer made of tungsten or the layer made of molybdenum can be 20 μm to 30 μm, the thickness of the nickel layer can be 2 μm to 8 μm, and the thickness of the gold layer can be 1 μm to 4 μm. Thus, it can be considered that the nickel layer and the gold layer do not affect heat transfer between the tungsten layer or the molybdenum layer forming the bump 181 and the planar lightwave circuit 400.

In the present embodiment, as shown in FIG. 2, the conductive adhesive layer 182 is preferably formed in at least a part of a region where the bumps 181 on the metallic pad 183 are not arranged.

The conductive adhesive layer 182 bonds and fixes the metallic pad 183 with the planar lightwave circuit 400 and the chip-on-carrier 200. That is, the chip-on-carrier 200 is installed on the metallic pad 183 via the conductive adhesive layer 182. The conductive adhesive layer 182 may be provided if necessary or may not be provided if not necessary, or may be formed in the entire region where the bumps 181 on the metallic pad 183 are not arranged.

The conductive adhesive layer 182 is made of a cured conductive adhesive containing resin and conductive particles. The thermal conductivity of the conductive adhesive layer 182 ranges from 1 W/mK to 50 W/mK and is determined in accordance with types and proportions of resins and conductive particles contained in the conductive adhesive.

Examples of the resins include epoxy resins, phenol resins, and the like. Examples of the conductive particles include silver, copper, nickel, and the like. As a conductive adhesive for forming the conductive adhesive layer 182, it is preferable to use silver paste containing epoxy resins and silver particles because they have high adhesive strength, high heat resistance, little volume shrinkage during curing, and little degassing after curing.

In the present embodiment, as shown in FIGS. 1 and 2, four thermal vias 180 are provided to penetrate through the substructure 185. Two of the four thermal vias 180 are provided at positions at least partially overlapping the planar lightwave circuit 400 and the bumps 181 when seen from above and the remaining two are provided at positions at least partially overlapping the chip-on-carrier 200 when seen from above.

The two thermal vias 180 provided at positions overlapping the planar lightwave circuit 400 when seen from above and at positions at least partially overlapping the bumps 181 has a structure in which a lower via 180a penetrating through a first base material 185a installed on the lower side within the substructure 185 of a two-layer structure and an upper via 180c penetrating through the second base material 185b installed on the upper side within the substructure 185 are connected. As shown in FIG. 2, the two thermal vias 180 provided at positions at least partially overlapping the chip-on-carrier 200 when seen from above have a structure in which a lower via 180b penetrating through a first base material 185a and an upper via 180d penetrating through a second base material 185b are connected.

In the present embodiment, the lower vias 180a and 180b and the upper vias 180c and 180d have substantially concentric cylindrical shapes. The diameters of the lower vias 180a and 180b are larger than those of the upper vias 180c and 180d. The planar shapes and sizes of the lower vias 180a and 180b and the upper vias 180c and 180d are not particularly limited and can be appropriately determined in accordance with the number of thermal vias 180, a size of the planar lightwave circuit 400, thicknesses of the first base material 185a and the second base material 185b, and the like.

Although an example in which the two thermal vias 180 provided at positions overlapping the planar lightwave circuit 400 when seen from above are arranged at positions at least partially overlapping the bumps 181 when seen from above will be described in the present embodiment, only some of the plurality of thermal vias 180 provided at positions overlapping the planar lightwave circuit 400 when seen from above may be arranged at positions at least partially overlapping the bumps 181 when seen from above. Therefore, for example, when a plurality of thermal vias 180 arranged at a prescribed pitch and a plurality of bumps 181 arranged at a prescribed pitch are provided, the pitches of the thermal vias 180 and the pitches of the bumps 181 may be the same or different.

Although an example in which the two thermal vias 180 provided at positions overlapping the planar lightwave circuit 400 when seen from above are both arranged in the region where the bumps 181 are formed when seen from above will be described in the present embodiment, one or both of the two thermal vias 180 provided at positions overlapping the planar lightwave circuit 400 when seen from above are only partially arranged in a region where the bumps 181 are formed when seen from above.

In the present embodiment, the number of thermal vias 180 is not particularly limited and can be appropriately determined in accordance with the number and sizes of chip-on-carriers 200 and the number and sizes of planar lightwave circuits 400.

The thermal via 180 preferably has a thermal conductivity of 135 W/mK to 210 W/mK. Specifically, the thermal via 180 is preferably made of tungsten (W: thermal conductivity of 150 W/mK to 180 W/mK) or molybdenum (Mo: thermal conductivity of 135 W/mK to 150 W/mK). This is because the light source module 100 can be manufactured using a method of baking the substructure 185 after holes serving as the lower vias 180a and 180b and the upper vias 180c and 180d provided in the first base material 185a and the second base material 185b, respectively, are filled with materials for forming the thermal vias 180 in a known method.

In the present embodiment, as shown in FIG. 2, the thermal pad 184 is provided around the thermal vias 180 on the lower surface of the substructure 185. The thermal pad 184 may be provided in only a region surrounding the thermal vias 180 on the lower surface of the substructure 185 or may be provided in a region other than a region surrounding the thermal vias 180. The thermal pad 184 may be provided, for example, on the entire bottom surface of substructure 185.

A sidewall portion 132 of the housing portion 107 is made of an insulating material. The sidewall portion 132 is made of, for example, aluminum nitride (AlN), aluminum oxide (Al₂O₃), or the like. The sidewall portion 132 may be made of the same material as the substructure 185 or may be made of a material different from that of the substructure 185.

In the present embodiment, as shown in FIG. 1, a plurality of internal electrode pads 202 are provided at intervals in the x-direction at positions on the external electrode pads 210 side of the chip-on-carrier 200 on the bottom surface 131 of the housing portion 107. The internal electrode pad 202 corresponding to each laser diode 30 among the plurality of internal electrode pads 202 is connected to each of the laser diodes 30 and the subcarriers 20 through wires 95.

Specifically, for example, the laser diode 30-1 and the subcarrier 20-1 are separately connected to the two internal electrode pads 202-1 through wires 95-1. The laser diode 30-2 and the subcarrier 20-2 are separately connected to the two internal electrode pads 202-2 through wires 95-2.

The laser diode 30-3 and the subcarrier 20-3 are separately connected to the two internal electrode pads 202-3 through wires 95-3.

The internal electrode pads 202-1, 202-2, and 202-3 are electrically connected to external electrode pads 210 different from each other. An external electrode pad 210 electrically connected to each of the internal electrode pads 202-1. 202-2, and 202-3 is electrically connected to wiring or the like connected to a power supply.

As shown in FIGS. 1 and 2, an opening 133 is formed in a sidewall portion 132-1 facing the output surface 64 of the optical waveguide 50 of the planar lightwave circuit (PLC) 400 among the sidewall portions 132 forming the housing portion 107 of the package 110. In the sidewall portion 132-1, the opening 133 is formed to be substantially centered at a position intersecting the optical axis of the three-color light output from the core 51-4 of the optical waveguide 50. The opening 133 is a window through which the three-color light output from the core 51-4 of the optical waveguide 50 propagates to the outside of the package 110. The opening 133 is tightly covered with a glass plate 220 from the outside of the sidewall portion 132.

The electrode portion 108 of the package 110 is arranged behind the housing portion 107 in the y-direction, as shown in FIGS. 1 and 2. As shown in FIG. 1, a plurality of external electrode pads 210 are provided on the upper surface of the electrode portion 108 at intervals in the x-direction.

### Manufacturing Method

The light source module 100 of the present embodiment shown in FIG. 1 can be manufactured, for example, in a method to be described below.

First, the laser diode (LD) 30 is mounted on the upper surface 21 of the subcarrier (base) 20 via the metallic layer 75 using known technology. Thereby, the chip-on-carrier 200 is manufactured (see FIG. 3).

Subsequently, the optical waveguide 50 is formed on the upper surface 41 of the substrate 40 in a known semiconductor process. Thereby, the planar lightwave circuit (PLC) 400 is manufactured (see FIG. 3).

Subsequently, using known technology, the subcarrier 20 on which the laser diode 30 is mounted and the substrate 40 on which the optical waveguide 50 is formed are bonded and integrated via the metallic bonding layer 71 (see FIG. 2). At this time, in the present embodiment, as shown in FIG. 2, the bottom surface of the subcarrier 20 and the bottom surface of the substrate 40 are bonded to be substantially on the same plane.

Next, the package 110 is manufactured in, for example, a method to be described below. First, the first base material 185a serving as the substructure 185 is provided and two lower vias 180a are provided in a region where the planar lightwave circuit 400 is arranged when seen from above in a known method and two lower vias 180b are provided in a region where the chip-on-carrier 200 is arranged (see FIG. 1). Specifically, holes serving as the lower vias 180a and 180b are provided in the first base material 185a and the holes are filled with a material for forming the lower vias 180a and 180b in a known method.

Subsequently, the thermal pad 184 is formed around at least the thermal via 180 on the surface that becomes the lower surface of the substructure 185 of the first base material 185a in a known method (see FIG. 2). Subsequently, wiring (not shown) having a prescribed pattern shape is provided in a known method on the surface of the first base material 185a on which the second base material 185b is arranged.

Next, the second base material 185b is laminated on the first base material 185a and the upper vias 180c are provided at positions overlapping the two lower vias 180a when seen from above and the upper vias 180d are provided at positions overlapping the two lower vias 180b when seen from above in a known method (see FIG. 2). Specifically, holes serving as the upper vias 180c and 180d are formed in the second base material 185b and the holes are filled with a material for forming the upper vias 180c and 180d in a known method. Thereby, the substructure 185 having the four thermal vias 180 penetrating through the substructure 185 and serving as the bottom surface 131 of the Next, in a known method, the metallic pad 183 is provided on the substructure 185 in the entire region where the planar lightwave circuit 400 and the chip-on-carrier 200 are arranged when seen from above. package 110 is formed.

Next, in the present embodiment, the four bumps 181 are formed in a known method such as a method of printing a material for forming the bumps 181 in a region where the planar lightwave circuit 400 is arranged on the metallic pad 183. At this time, in the present embodiment, two of the four bumps 181 are formed at positions overlapping the thermal vias 180 when seen from above.

Next, the substructure 185 on which the layers up to the bump 181 are formed is sintered in a known method. Sintering can be performed according to known methods and conditions, and can be performed at a temperature of 1500° C. or higher, for example, 1600° C.

Next, a plurality of internal electrode pads 202 are provided in a known method such as a plating method on the substructure 185 at a position on the external electrode pad 210 side in a region where the chip-on-carrier 200 is arranged when seen from above in a known method.

When the bumps 181 are formed by laminating a nickel layer and a gold layer in that order on a layer made of tungsten or a layer made of molybdenum, it is preferable to form a nickel layer and a gold layer in that order on the layer made of tungsten or the layer made of molybdenum after sintering, simultaneously when the internal electrode pads 202 are provided in a plating method.

Next, using a method such as wire bonding, a connection between each of the laser diode 30-1 and the subcarrier 20-1 and each of the two internal electrode pads 202-1, a connection between each of the laser diode 30-2 and the subcarrier 20-2 and each of the two internal electrode pads 202-2, and a connection between each of the laser diode 30-3 and the subcarrier 20-3 and each of the two internal electrode pads 202-3 are separately established through wires 95-1, 95-2, and 95-3 made of gold (Au) or the like, respectively.

Next, a plurality of external electrode pads 210 are provided at positions where the electrode portions 108 are formed on the substructure 185 in a known method.

Subsequently, the sidewall portions 132 are formed between the electrode pad 202 on the substructure 185 and the external electrode pad 210 and on the edge other than the external electrode pad 210 side of the substructure 185. Thereby, the housing portion 107 having a substantially rectangular shape when seen from above is formed and the electrode portion 108 adjacent to the housing portion 107 is formed. At this time, the opening 133 is provided in the sidewall portion 132-1 facing the output surface 64 of the optical waveguide 50 of the planar lightwave circuit 400 in a known method.

Next, the metallic film 112 made of Kovar or the like is formed on the upper surface of the sidewall portion 132 in a known method.

Subsequently, the opening 133 is tightly covered with the glass plate 220 from the outside of the sidewall portion 132, a cover (not shown) is installed to cover the upper surface of the housing portion 107, and the housing portion 107 is filled with an inert gas nitrogen (N₂) and hermetically sealed.

Through the above steps, the light source module 100 shown in FIG. 1 is obtained.

### Usage Method

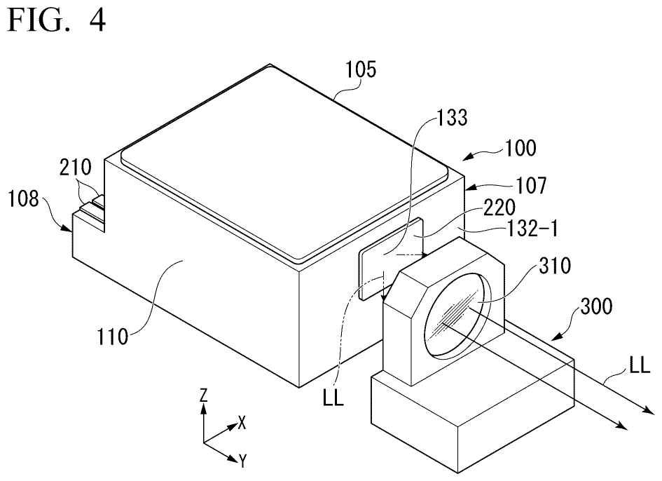

FIG. 4 is a perspective view showing an example of a method using the light source module shown in FIGS. 1 to 3. In FIG. 4, members identical to those of the light source modules shown in FIGS. 1 to 3 are denoted by the same reference signs and descriptions thereof are omitted.

In FIG. 4, reference sign 300 denotes a collimating device and reference sign 310 denotes a collimating lens provided in the collimating device 300.

As shown in FIG. 4, the light source module 100 is hermetically sealed by covering the upper surface of the housing portion 107 of the package 110 with a cover 105. The light source module 100 shown in FIG. 4 outputs three-color light LL via the glass plate 220 from the opening 133 provided in the sidewall portion 132-1 of the housing portion 107. The three-color light LL output from the light source module 100 travels forward in the y-direction of the package 110 while diffusing around the y-direction.

As shown in FIG. 4, the collimating device 300 is arranged on the deeper side in the y-direction than the sidewall portion 132-1 of the package 110 of the light source module 100. The three-color light LL output from the package 110 is collimated into parallel light by adjusting a distance between the y-direction output surface of the laser diode (LD) 30 of the light source module 100 and the collimating lens 310 to a focal length of the collimating lens 310 and aligning the center of the collimating lens 310 on the optical axis of the light.

In the light source module 100 of the present embodiment, the base 20 of the chip-on-carrier 200, the substrate 40 of the planar lightwave circuit 400, the substructure 185 of the package 110, the thermal vias 180, and the bumps 181 each have the thermal conductivity described above. Two of the bumps 181 in contact with the planar lightwave circuit 400 are arranged at positions at least partially overlapping the thermal vias 180 when seen from above. Therefore, heat generated by the laser diode (LD) 30 and moved to the substrate 40 via the base 20 can be efficiently radiated along a heat radiation path passing through the bumps 181 and the thermal vias 180 in that order. Therefore, the light source module 100 of the present embodiment has high heat radiation performance.

Furthermore, in the light source module 100 of the present embodiment, when the base 20 and the substrate 40 are bonded via the metallic bonding layer 71, the heat generated by the laser diode (LD) 30 is more efficiently transferred from the base 20 to the substrate. 40 via the metallic bonding layer 71. As a result, the light source module 100 has better heat radiation performance.

Also, in the light source module 100 of the present embodiment, the metallic pad 183 is arranged in a region where the planar lightwave circuit 400 is arranged on the substructure 185 when seen from above, and the bump 181 is arranged on the metallic pad 183 in contact therewith. Thus, in the light source module 100 of the present embodiment, heat generated by the laser diode (LD) 30 is efficiently transmitted from the bumps 181 in contact with the planar lightwave circuit 400 to the thermal vias 180 via the metallic pads 183. As a result, the light source module 100 has better heat radiation performance.

Furthermore, in the present embodiment, the metallic pad 183 is provided to extend over a region where the chip-on-carrier 200 is arranged on the substructure 185 when seen from above and the chip-on-carrier 200 is installed on the metallic pad 183 via the conductive adhesive layer 182. Thus, in the light source module 100 of the present embodiment, the heat generated by the laser diode (LD) 30 is also radiated from the heat radiation path of the base 20, the conductive adhesive layer 182, the metallic pad 183, and the thermal via 180. As a result, the light source module 100 has better heat radiation performance.

Also, because the thermal pad 184 is arranged around the thermal vias 180 on the lower surface of the substructure 185 in the light source module 100 of the present embodiment, heat generated by the laser diode (LD) 30 can be efficiently radiated along a heat radiation path of the base 20, the substrate 40, the bumps 181, the thermal vias 180, and the thermal pad 184.

### XR Glasses

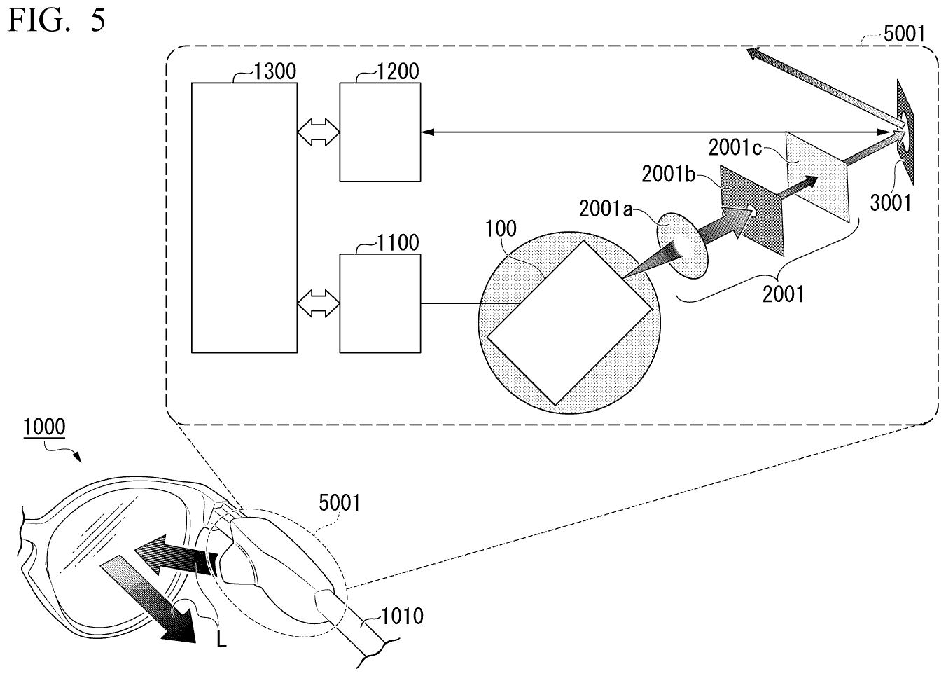

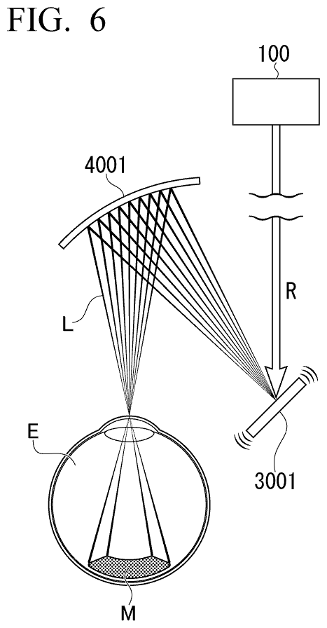

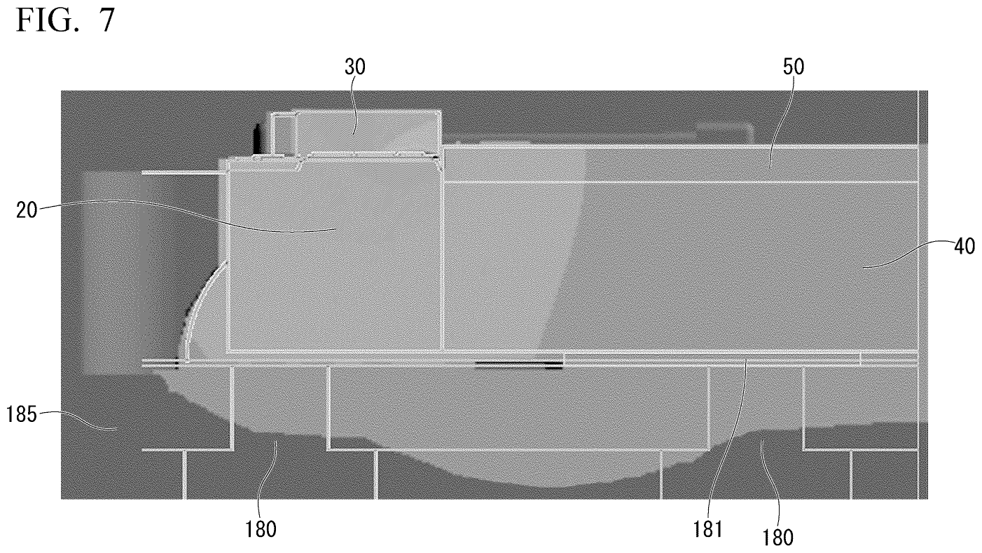

FIG. 5 is a conceptual diagram for describing an example of XR glasses of the present disclosure. FIG. 6 is a conceptual diagram showing a state in which an image is directly projected onto a retina by laser light output from the light source module in the XR glasses shown in FIG. 5.

XR glasses (eyeglasses) 1000 of the present embodiment are glasses-type terminals. XR is a general term for virtual reality (VR), augmented reality (AR), and mixed reality. Reference sign L shown in FIG. 5 denotes image display light.

The XR glasses 1000 of the present embodiment shown in FIG. 5 are obtained by mounting the light source module 100 according to the embodiment described above on an optical engine 5001 installed on a frame 1010.

As shown in FIG. 5, the optical engine 5001 includes the light source module 100, an optical scanning mirror 3001, an optics system 2001 connecting the light source module 100 and the optical scanning mirror 3001, a laser driver 1100, an optical scanning mirror driver 1200, and a video controller 1300 that controls these drivers.

As the optical scanning mirror 3001, for example, a MEMS mirror can be used. In order to project a 2D image, as the optical scanning mirror 3001, a biaxial MEMS mirror that vibrates to reflect the laser light by changing the angle in the horizontal direction (X-direction) and the vertical direction (Y-direction) can be preferably used.

The optics system 2001 optically processes the laser light output from the light source module 100. For example, the optics system 2001 having a collimator lens 2001a, a slit 2001b, and an ND filter 2001c can be used. The optics system 2001 shown in FIG. 5 is an example and may have another configuration.

In the XR glasses 1000 of the present embodiment shown in FIG. 5, as shown in FIG. 6, laser light R applied from the light source module 100 attached to the frame 1010 can be reflected by the optical scanning mirror 3001 and further reflected by a lens 4001 of the XR glasses 1000 and can enter a human eyeball Ε as image display light L and an image (a video) can be directly projected onto a retina M.

Because the light source module 100 of the present embodiment is mounted on the XR glasses 1000 of the present embodiment, heat generated by the laser diode (LD) 30 of the light source module 100 is efficiently radiated.

While embodiments of the present disclosure have been described in detail with reference to the drawings, configurations of the embodiments, a combination thereof, or the like are an example and additions, omissions, substitutions, and other modifications can be made without departing from the spirit or scope of the present disclosure.

For example, the light source module 100 of the present disclosure may have a known heat spreader installed at any position on the outer surface, such as a position in contact with the thermal pad 184 arranged on the lower surface of the substructure 185. For example, the heat spreader having any shape made of an alloy of tungsten and copper (CuW (Cu; 10 mol %, W; 90 mol %); thermal conductivity of 180 W/mK at 20° C.) can be used. By providing the heat spreader, the light source module 100 can more efficiently radiate the heat generated by the laser diode (LD) 30.

### EMBODIMENT EXAMPLES

### Embodiment Examples

A simulation was performed under the following conditions for the heat radiation state of the light source module 100 when the light source module 100 shown in FIGS. 1 to 3 was produced using the materials shown below. The results are shown in FIG. 7.

### <Materials>

The thermal conductivity of each material in the present embodiment example is the thermal conductivity at a temperature of 20° C.
Subcarrier (base) 20: silicon (Si: thermal conductivity of 149 W/mK)
Substrate 40: silicon (Si: thermal conductivity of 149 W/mK)
Metallic bonding layer 71: tin (Sn)-silver (Ag)-copper (Cu)-based solder alloy (SAC: thermal conductivity of 55 W/mK)

### (Substructure 185)

First base material 185a: aluminum oxide (Al₂O₃: thermal conductivity of 15 W/mK)

Second base material 185b: aluminum oxide (Al₂O₃: thermal conductivity of 15 W/mK) (thermal via 180)
Lower vias 180a and 180b: tungsten (W: thermal conductivity of 173 W/mK)
Upper vias 180c and 180d: tungsten (W: thermal conductivity of 173 W/mK)
Thermal pad 184: tungsten (W: thermal conductivity of 173 W/mK)
Metallic pad 183: tungsten (W: thermal conductivity of 173 W/mK)
Bump 181: tungsten (W: thermal conductivity of 173 W/mK) thickness of 30 μm
Conductive adhesive layer 182: silver paste (thermal conductivity of 3 W/mK)

### <Conditions>

Bottom surface (thermal pad 184) temperature of light source module 100: 40° C. (constant) (operating current and forward voltage of laser diode (LD))
LD 30-1 (red light): operating current of 45 mA (maximum value at 25° C.), forward voltage: 2.3 V (25° C. typ.)
LD 30-2 (green light): operating current of 32 mA (standard value at 25° C.), forward voltage: 6.0 V (25° C. typ.)
LD 30-3 (blue light): operating current of 20 mA (standard value at 25° C.), forward voltage: 4.6 V (25° C. typ.)

### Comparative Examples

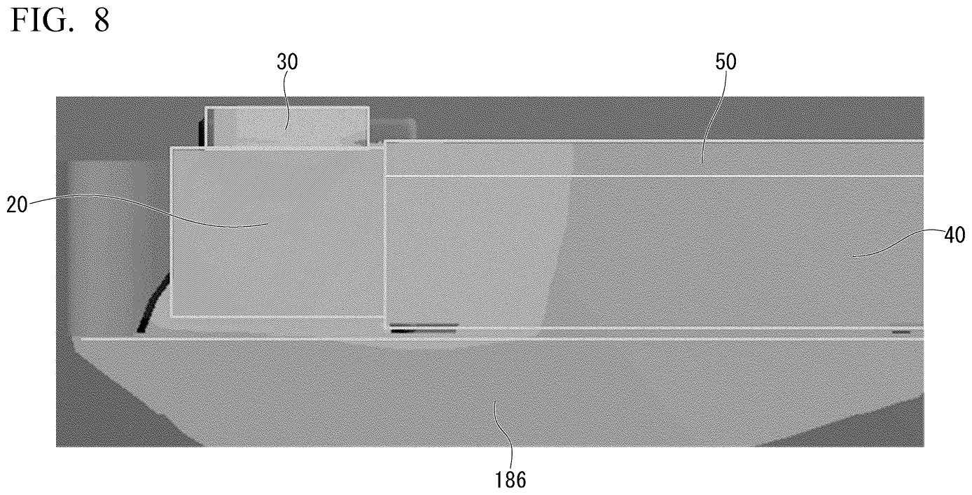

A simulation was performed as in the embodiment examples for the heat radiation state of the light source modale when the light source module 100 identical to that of the embodiment example was fabricated except that the lower via and the upper via were not provided. The results are shown in FIG. 8.

FIG. 7 is a cross-sectional view showing a heat distribution of a region of the subcarrier 20 and the substrate 40 near the subcarrier 20 when the light source module of the embodiment example is cut along line A-A′ shown in FIG. 1. FIG. 8 is a cross-sectional view showing a heat distribution when a light source module of a comparative example is cut at a position corresponding to the light source module of the embodiment example.

The brightness of the color in the heat distributions shown in FIGS. 7 and 8 varies with each temperature of 1.5° C. The portion of the substructure 185 in FIG. 7 and the portion of the base 186 in FIG. 8 are shown so that the color is whiter in a region where the temperature is higher and the color is blacker in a region where the temperature is lower.

As shown in FIG. 7, in the light source module 100 of the embodiment example, a temperature distribution occurred in the height direction at the substructure 185 arranged below the substrate 40 near the subcarrier 20. In more detail, in the substructure 185 of the two-layer structure arranged below the substrate 40 near the subcarrier 20, the first base material installed on the lower side has a lower region that is at a lower temperature than an upper region. Also, as shown in FIG. 7. the temperature in the lower region was lower than that in the upper region in the two thermal vias 180 as well. Also, as shown in FIG. 7, a position of a boundary between the lower temperature region and the higher temperature region in the thermal via 180 is higher than that in the substructure 185. From this, it could be confirmed that the heat generated by the laser diode 30 was radiated along a heat radiation path passing through the chip-on-carrier base 20 and the thermal via 180 in that order and along a heat radiation path passing through the chip-on-carrier base 20, the planar lightwave circuit substrate 40, the bump 181, the metallic pad 183, and the thermal via 180 in that order.

On the other hand, as shown in FIG. 8, in the light source module of the comparative example, the temperature distribution in the height direction could not be confirmed at the base 186 arranged below the substrate 40 near the subcarrier 20. From this, it could be confirmed that heat radiation performance deteriorated as compared with the light source module 100 of the embodiment example in the light source module of the comparative example.

### EXPLANATION OF REFERENCES

20, 20-1, 20-2, 20-3 Subcarrier (base)
21, 21-1, 21-2, 21-3, 41 Upper surface
30, 30-1, 30-2, 30-3 Laser diode (LD)
40 Substrate
50 Optical waveguide
51-1, 51-2, 51-3, 51-4 Core
52 Cladding
57-1, 57-2 Merging position
61 Input surface
64 Output surface
71 Metallic bonding layer
75 Metallic layer
95, 95-1, 95-2, 95-3 Wire
100 Light source module
105 Cover
107 Housing portion
108 Electrode portion
110 Package
112 Metallic film
131 Bottom surface
132, 132-1 Sidewall portion
133 Opening
180 Thermal via
180a, 180b Lower via
180c, 180d Upper via
181 Bump
182 Conductive adhesive layer
183 Metallic pad
184 Thermal pad
185 Substructure
185a First base material
185b Second base material
200 Chip-on-carrier
202, 202-1, 202-2, 202-3 Internal electrode pad
210 External electrode pad
220 Glass plate
300 Collimating device
310 Collimating Jens
400 Planar lightwave circuit (PLC)
1000 XR glasses (eyeglasses)
1010 Frame
5001 Optical engine

What is claimed is:

1. A light source module comprising:
a chip-on-carrier having a base and a laser diode mounted on the base;
a planar lightwave circuit having a substrate bonded to the base and an optical waveguide provided on the substrate and to which light emitted from the laser diode is input; and
a package having a housing portion configured to house the chip-on-carrier and the planar lightwave circuit,
wherein the housing portion has a substructure configured to form a bottom surface, one or more thermal vias penetrating through the substructure, and one or more bumps provided on the substructure,
wherein at least one of the bumps is arranged in contact with the planar lightwave circuit and arranged at a position at least partially overlapping the thermal vias when seen from above, and
wherein the bumps come in contact with the thermal vias or the bumps and the thermal vias are bonded via a metallic pad.

2. The light source modole according to claim 1,
wherein the base has a thermal conductivity of 120 W/mK to 170 W/mK,
wherein the substrate has a thermal conductivity of 120 W/mK to 170 W/mK,
wherein the substructure has a thermal conductivity of 3 W/mK to 40 W/mK,
wherein the thermal via has a thermal conductivity of 135 W/mK to 210 W/mK,
wherein the bump has a thermal conductivity of 80 W/mK to 210 W/mK, and
wherein the metallic pad has a thermal conductivity of 55 W/mK to 65 W/mK.

3. The light source module according to claim 1,
wherein the base and the substrate are made of a material containing silicon,
wherein the substructure is made of aluminum oxide, and
wherein the bumps and the thermal vias are made of tungsten or molybdenum.

4. The light source module according to claim 1, wherein the base and the substrate are bonded via a metallic bonding layer having a thermal conductivity of 55 W/mK to 65 W/mK.

5. The light source module according to claim 1,
wherein the metallic pad is arranged in at least a region where the planar lightwave circuit is arranged on the substructure when seen from above, and
wherein the bump is arranged on the metallic pad in contact therewith.

6. The light source module according to claim 5,
wherein the metallic pad is provided to extend to a region where the chip-on-carrier is arranged on the substructure when seen from above, and
wherein the chip-on-carrier is installed on the metallic pad via a conductivity adhesive layer having a thermal conductivity of 1 W/mK to 50 W/mK.

7. XR glasses on which the light source module according to claim 1 is mounted.

8. XR glasses on which the light source module according to claim 3 is mounted.

9. XR glasses on which the light source module according to claim 4 is mounted.

10. XR glasses on which the light source module according to claim 5 is mounted.

11. XR glasses on which the light source module according to claim 6 is mounted.

12. The light source module according to claim 2,
wherein the base and the substrate are made of a material containing silicon,
wherein the substructure is made of aluminum oxide, and
wherein the bumps and the thermal vias are made of tungsten or molybdenum.

13. The light source module according to claim 2, wherein the base and the substrate are bonded via a metallic bonding layer having a thermal conductivity of 55 W/mK to 65 W/mK.

14. The light source module according to claim 2,
wherein the metallic pad is arranged in at least a region where the planar lightwave circuit is arranged on the substructure when seen from above, and
wherein the bump is arranged on the metallic pad in contact therewith.

15. The light source module according to claim 14,
wherein the metallic pad is provided to extend to a region where the chip-on-carrier is arranged on the substructure when seen from above, and
wherein the chip-on-carrier is installed on the metallic pad via a conductivity adhesive layer having a thermal conductivity of 1 W/mK to 50 W/mK.

16. XR glasses on which the light source module according to claim 2 is mounted.

17. XR glasses on which the light source module according to claim 12 is mounted.

18. XR glasses on which the light source module according to claim 13 is mounted.

19. XR glasses on which the light source module according to claim 14 is mounted.

20. XR glasses on which the light source module according to claim 15 is mounted.
